(19) United States
(12) Patent Application Publication
(10) Pub. No.: US 2014/0245199 A1
(43) Pub. Date: Aug. 28, 2014

(54) METHOD AND SYSTEM FOR CUSTOMIZING A GUI OF A MES SCREEN

(71) Applicant: SIEMENS AKTIENGESELLSCHAFT, MUENCHEN (DE)

(72) Inventors: SIMONE BELOTTI, GENOVA (IT); STEFANO NOFERI, GENOA (IT)

(73) Assignee: SIEMENS AKTIENGESELLSCHAFT, MUENCHEN (DE)

(21) Appl. No.: 14/190,339

(22) Filed: Feb. 26, 2014

(30) Foreign Application Priority Data
Feb. 28, 2013 (EP) 13157121.8

(51) Int. Cl. G06F 3/0484

(52) U.S. Cl. CPC G06F 3/0484
USPC 715/762

(57) ABSTRACT

A method and a system customize a user-interface for a page-screen of an MES software application. Within an MES application a page-screen contains a configurable graphic control that contains a custom area customizable via a plug-in. A graphic configuration tool for enabling the configuration of the configurable graphic control is provided. At engineering time a configurable plug-in is provided, wherein its software code contains an additional configurable graphic control containing its custom area customizable via a nested plug-in. It is specified, through the configuration tool, the information of the configurable plug-in. The page-screen is explored so that, under the node representing the configurable graphic control, a tree is presented having a node representing the configurable plug-in having, underneath, a node representing the additional configurable graphic control. A specific node is selected and represents a specific additional configurable graphic control to be customized according to an additional given customer requirement.

### CROSS-REFERENCE TO RELATED APPLICATION

This application claims the priority, under 35 U.S.C. §119, of European application EU 13157121.8, filed Feb. 28, 2013; the prior application is herewith incorporated by reference in its entirety.

### BACKGROUND OF THE INVENTION

### Field of the Invention

The present invention relates to a method and to a system for customizing a graphical user interface (GUI) of a manufacturing execution system (MES) screen.

As defined by the Manufacturing Enterprise Solutions Association (MESA International), a MES system “is a dynamic information system that drives effective execution of manufacturing operations”, by managing “production operations from point of order release into manufacturing to point of product delivery into finished goods” and by providing “mission critical information about production activities to others across the organization and supply chain via bi-directional communication.” The international standard for developing MES systems is commonly referred as ISA-95 or S95.

The goal of MES systems developed by software suppliers is to provide manufacturing companies (the customers) with tools for measuring and controlling production activities with the aim of boosting profitability, increasing productivity, improving quality and process performance in manufacturing plants.

As used herein, a software application is a set of software components developed by software developers to perform some useful actions within a MES system, e.g. monitoring values coming from plant process or controlling a plant device.

Typically, at engineering or configuration time, system engineers flexibly customize MES applications according to specific customer requirements.

Instead, at runtime, MES applications are utilized by end-users who may be plant operators or line responsible personnel.

Usually, MES systems are provided with front-end/client GUI applications which are used by end-users to plan and control manufacturing activities.

MES GUI applications play a key role in bringing together process, quality and business information from various sources into one unified real-time view of the production status of the plant. In fact, MES GUI applications display to the end-user graphical screens which enable overview several parameters or scenarios of the plant activities.

Nowadays MES screens are mostly developed in form of web-pages. For example, with MES application suite SIMATIC IT, it is provided a Client Application Builder which is composed of a set of modules allowing users to build customized GUI screen-pages.

Typically, software suppliers develop a MES software-product as a general purpose solution to meet several different customer requirements. As a consequence to it, also the collections of MES screens, which are supplied with the MES product, are designed to be general purpose in order to be used in various different situations.

However, since customers usually require that MES products be customized for a specific project fitting their specific needs, also the GUIs of MES screens need to be customized in order to satisfy the customer requirements of the specific project. This customer need is a fundamental one since the end-users, at the customer site, interact with the MES product mainly through the GUI of the MES-screens. In summary, usually, the web pages screens of MES products are delivered to the customer with predefined layouts and, thus, MES screens developed at the product level often have to be customized to match customers' needs.

As taught in the description of the published, European patent application EP 111 95 274.3 filed by Siemens, hereinafter referred as Document A [Ref.1], in order to obtain this requirement without changing the source code of the page screens, a configuration system has been proposed for customizing the layout and the behavior of the page-screens. Document A [Ref.1] describes a technique for customizing a user-interface of a screen of a general purpose MES software application taking into account a specific customer requirement. The configuration system according to Document A [Ref.1] contains a graphic configuration tool enabling the configuration of a configurable graphic control of the page screen. Such configurable graphic control contains at least a custom area. At engineering time, an additional ASP.net control is developed by writing its software code to implement the specific customer requirement. The developed additional ASP.net control acts as a plug-in and it allows to add or to deeply modify the functionalities of a page screen: the graphic configuration tool itself allows browsing and selecting a custom area of the configurable graphic control and linking it to the developed plug-in software code.

Hence, thanks to the technique disclosed in Document A [Ref.1], system integrators are enabled to customize the product screens by adding some plug-ins in predefined custom areas of the configurable graphic controls.

With such technique, it is possible to develop plug-ins which meet specific needs of a specific customer without changing the source code of the page screen. However, with such a technique, the developed plug-in cover only the specific requirement for which they were developed for.

In fact, the drawback of this technique is that, in case it is desired to implement slight changes to the plug-in behavior, the source code of the plug-in itself has to be changed and a fix might need to be released. Hence, in real case scenarios, the probability of re-using the developed plug-in in different page screens of same or of different customers is very low since slight behavioral changes are often required. As a consequence, due to the fact that slight changes of the plug-in behavior are often required, the drawback of this technique is that it often leads to a growth of similar plug-ins to meet similar different customer needs.

Up to now this problem has been solved by developing a multitude of plug-ins in order to satisfy all the required customer needs and desired features. It is evident to those skilled in the art, the involved costs in maintaining the software codes of a large number of plug-ins. For example, it is often the case that the customization of the product page-screens is made per industry, e.g. pharmaceutical, automotive etc. Thus MES product page-screens are delivered to the customer after having being customized through configurations and through developed plug-ins to satisfy general requirements of the customer specific industry.

However, when the system integrators of the customers receive the product page-screens which are usually industry specific, they still need to provide additional customizations to match the specific requirements of the specific customer project. Up until now, the system integrator problem is that they are unable to configure the plug-ins delivered together with the original page screen, since in order to change the behavior of one given plug-in they had to rewrite the given plug-in code and substitute the delivered given plug-in with their own new custom plug-in.

### SUMMARY OF THE INVENTION

It is therefore the aim of the present invention to overcome the above mentioned drawbacks, in particular by providing a method and a system for customizing a GUI of a MES screen without modifying the source code of a given plug-in to be used together with the page-screen.

The aforementioned aim is achieved by a method and a system for customizing a user-interface of a screen of a general purpose MES software application taking into account a set of customer requirements, the screen being a web-page, hereinafter called page-screen. The method includes:

a) providing within the MES application at least one page-screen containing at least one configurable graphic control that contains at least one area that can be customized via at least one plug-in, the one area being called custom area;
b) providing a graphic configuration tool for enabling the configuration of the configurable graphic control of the page-screen user-interface in the at least one custom area;
c) enabling the at least one plug-in to be configured, the plug-in being a configurable plug-in;
d) enabling the configuration tool to configure the configurable plug-in;
e) at engineering time, through the configuration tool, exploring the page-screen so that, a tree is presented in which there is at least one node representing a configurable graphic control;
f) at engineering time, selecting a given node representing a given configurable graphic control and at least one associated custom area to be customized according to a given customer requirement thorough the configurable plug-in;
g) at engineering time, providing the configurable plug-in, wherein its software code contains at least one additional configurable graphic control containing its custom area customizable via a nested plug-in;
h) at engineering time, specifying, through the configuration tool, the information of the configurable plug-in for linking it to the custom area of the configurable graphic control;
i) at engineering time, through the configuration tool, exploring the page-screen so that, under the node representing the configurable graphic control, a tree is presented in which there is at least one node representing the configurable plug-in having, underneath, at least one node representing the at least one additional configurable graphic control;
j) at engineering time, selecting a specific node representing a specific additional configurable graphic control containing at least one associated custom area to be customized according to an additional given customer requirement;
k) at engineering time, providing the nested plug-in which meets the additional given customer requirement; and
l) at engineering time, specifying, through the configuration tool, the information of the nested plug-in for linking it to the custom area of the additional configurable graphic control.

In inventive embodiments, a nested plug-in may be conveniently enabled to be configurable as well in order to meet further customer requirement by including in its software code at least one further configurable graphic control containing at least one associated custom area customizable via a sub-nested plug-in; and by performing items i) to l) accordingly, e.g. where the terms “configurable graphic control” are substituted with the terms “further configurable control”, the terms “additional given customer requirement” with the terms “further customer requirement”, the terms “configurable plug-in” with the terms “configurable nested plug-in”, the terms “nested plug-in” with the terms “sub-nested plug-in”.

In an inventive embodiment, at run time, a user-interface of a screen of a general purpose MES software application may preferably be customized according to the invention or its embodiments.

Inventive embodiments may advantageously include the storing, at engineering time, of the information of items h) and l) on the web server or on a database.

Furthermore, a computer program element can be provided, containing computer program code for performing steps according to the above mentioned method when loaded in a non-transitory memory of a digital processor of a computing device.

Additionally, a computer program product stored on a computer usable medium can be provided, containing computer readable program code for causing a computing device to perform the mentioned method.

With these inventive embodiments, it is provided a wide set of new possibilities of customizations of the existing general purpose page screens according to required specific customer needs, so that MES screens can be customized through a hierarchical plug-in configuration system. Such new possible customizations do not require that system integrators re-write the code of the original page screen or the code of its configurable plug-in.

This result is obtained without the need to re-write the code of the original screen, but only by configuring the needed portions of the screens.

With inventive embodiments, the core technology of the configuration system is integrated in the plug-in technology; in such a way that the technology developed for the page configuration has been extended also to the plug-ins so as to render them configurable as well. In this manner, it is possible to create a wide set of new possibilities of customization of existing screens since by lowering the amount of time needed to create the scenarios required by the customers and by making it easier to create an integrated solution.

According to further inventive embodiments, the configurable plug-ins created at a product or at a project level can be put together to create an entire library of customizations. In such a way, thanks to the short time needed to plug them in the existing page screens, it is possible to significantly lower the cost needed to make specific MES customer projects, thus being more competitive on the market.

The long time result of embodiments of the invention may conveniently be the creation of a set of general plug-ins that are specialized through their configuration for different needs. Once such library will be rich enough, it would be then fast and cheap to meet the customization requirements of customers, and the process will be codeless.

According to another inventive embodiment, not only the amount of time needed to create the customer customized scenario is greatly lowered but also maintenance costs are minimized.

Invention embodiments are compatible with the existing structure of the plug-in developed with technique described in Document A [Ref.1]. This means that also plug-ins which are previously developed with the technique of Document A [Ref.1], i.e. plug-ins which have configurable controls on the inside, benefit of the newly added configuration feature so that such plug-ins become configurable plug-ins.

Invention embodiments allow a high degree of design flexibility since they enable a recursive creation of nested plug-ins.

In summary, the truly interesting feature of the configurable plug-in is its capability to support other plug-ins. Such capability is advantageously achieved without any additional effort in the development process: when the plug-in is built with configurable controls, these controls already have built-in support for plug-ins. In this way, other plug-ins can be added to an existing plug-in to change or specialize its behavior and layout. As stated, this process can be done recursively, allowing a great degree of flexibility.

Other features which are considered as characteristic for the invention are set forth in the appended claims.

Although the invention is illustrated and described herein as embodied in a method and system for customizing a GUI of a MES screen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a snapshot example of a GUI configuration editor of a GUI configuration tool, according to an example embodiment of the previously described technique of Document A [Ref.1], namely the prior art; and

FIG. 2 is an illustration of a snapshot example of a GUI configuration editor of the GUI configuration tool, according to an example embodiment according to the invention.

### DETAILED DESCRIPTION OF THE INVENTION

According to the invention, a user-interface of a page-screen of a general purpose MES software application taking into account a set of customer requirements is customized. It is noted that the terms “general purpose” as used herein denote a MES product that require some specific customization being of general purpose. However, even an industry specific MES product is to be considered in this context to be of “general purpose” because it is not specifically customized according to specific needs of a given customer or project but only according to some specific needs of a given industry.

Within the MES application, it is provided at least one page-screen containing at least one configurable graphic control that contains at least one custom area that can be customized via a plug-in.

A graphic configuration tool is provided for enabling the configuration of the configurable graphic control of the page-screen user-interface in at least one custom area.

In addition, according to the proposed invention, the plug-in is configurable through the graphic configuration tool.

At engineering time, through the configuration tool, the page-screen is explored so that, a tree is presented in which there is at least one node representing a configurable graphic control.

At engineering time, a given node is selected, representing a given configurable graphic control, and at least one associated custom area to be customized according to a given customer requirement through the configurable plug-in.

At engineering time, the configurable plug-in meeting the given customer requirement is provided. The software code of the provided configurable plug-in contains at least one additional configurable graphic control containing at least one additional custom area which is customizable via another plug-in, called a nested plug-in.

At engineering time, through the configuration tool, it is specified the information of the configurable plug-in for linking it to the custom area of the configurable graphic control. Such information may conveniently be stored in a web-server or database. Such stored information is any information adequate to identify the plug-in in an univocal manner.

At engineering time, through the configuration tool, the page-screen is explored so that, under the node representing the configurable plug-in, a tree is presented in which there is at least one node representing the configurable plug-in having, underneath, at least one node representing the at least one additional configurable graphic control.

At engineering time, a specific node is selected, representing a specific additional configurable graphic control containing at least one associated custom area to be customized according to an additional given customer requirement.

At engineering time, the nested plug-in meeting the additional given customer requirement is provided.

At engineering time, through the configuration tool, it is specified the information of the nested plug-in for linking it to the custom area of the additional configurable graphic control. Such information may conveniently be stored on a web-server or database.

At run time, a user-interface of a screen of a general purpose MES software application may advantageously be displayed with the above described customizations.

In embodiments of the invention, the proposed invention can be reiterated so that the nested plug-in may advantageously rendered configurable in order to meet further customer requirements by including in its software code at least one further configurable graphic control containing at least one associated custom area customizable via a sub-nested plug-in. In further embodiments, the sub-nested plug-in may also become a configurable plug-in itself so as to obtain a recursive hierarchy of configurable plug-ins.

Example Embodiment: master-detail view according to an example embodiment of the present invention, it may be advantageously possible to specify custom procedures for adding detail information to a master/detail view in the user-interface of the page-screen.

In this example embodiment, a communication mechanism placed in the page-screen is preferably provided to allow at run time exchanging information between a configurable graphic control already present in the page-screen and the developed plug-in. For example, the type of the configurable graphic control may be tab type, panel type or a grid type.

Let us suppose that the page-screen, not shown, contains a master grid with a set of MES entities and that a first customer wishes to improve its usability by extending it with some details about a selected entry on the master grid. For example, the MES entities of the master grid are the working time on a shift calendar and the need of the first customer is to extend it so as to show also the breaks defined for a working time.

The technique disclosed in Document A [Ref.1] enables to implement the extension required by the first customer.

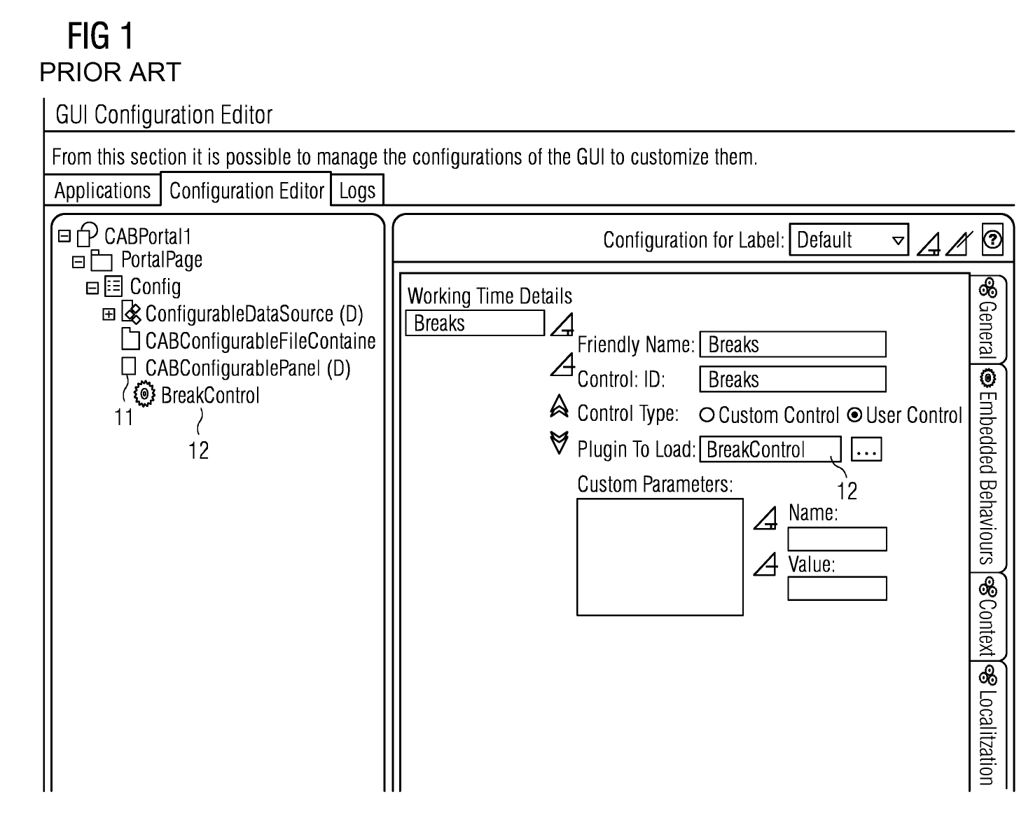

FIG. 1 is a snapshot example of a GUI configuration editor of the GUI configuration tool, for implementing such requirement of the first customer.

According to the technique described in Document A [Ref.1], in order to satisfy the requirement of the first customer, the system integrator has to be provided with a plug-in. The provided plug-in may have been developed by the system integrator himself/herself or alternatively may have been developed by the software developer. Then, the system integrator has to open the configuration tool and select the configurable control that contains a custom area. In FIG. 1 such configurable control with a custom area is called “CABConfigurablePanel” 11. In turn, the system integrator links the plug-in to the custom area. In FIG. 1 the plug-in to be loaded on the custom area of the Config Page is called “BreakControl” 12.

It is noted that, on the left side of the window shown in FIG. 1, underneath the “BreakControl” 12 plug-in node there are no more nodes, with the drawback of restraining the possibility to reuse the developed plug-in 12. In fact, let us suppose we are in a scenario in which a second customer needs a customization on the same page-screen of the first customer by additionally requiring additional information on the plug-in, for example who is/are the person/s currently on a selected break. In such a case, according to the previously described technique, the system integrator of the second customer would have to develop a new plug-in by duplicating the code of the previously described plug-in in order to add the additional desired feature.

Instead, with the proposed invention, the system integrator of the second customer is enabled to advantageously reuse the original plug-in since it is a configurable plug-in that can be extended with the new required functionality. The configuration tool is extended with all the available configuration points of the configurable plug-in so that the system integrator can change the layout and the behaviors of the plug-in without changing the source code of the plug-in itself: Instead of requiring the substitution of the plug-in, only a plug-in configuration is required.

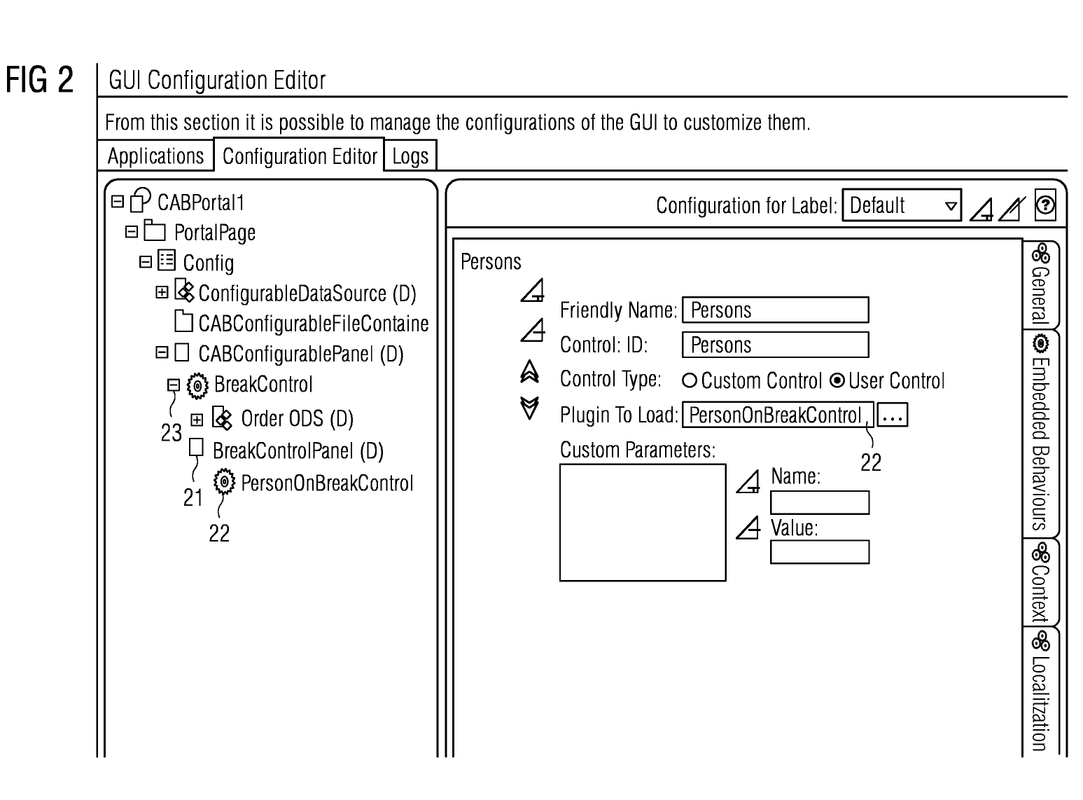

FIG. 2 is a snapshot example of a GUI configuration editor of the GUI configuration tool, for implementing the requirement of the second customer, according to an example embodiment of the present invention.

In order to do that, the system integrator has first to develop a new additional plug-in which meets the new required feature, this new plug-in in this example is called “PersonOnBreakControl” 22. In turn, she/he selects the configurable control that contains the custom area, in this example called “BreakControlPanel” 21. The system integrators links the newly developed additional plug-in “PersonOnBreakControl” 22 to the “BreakControlPanel” 21 custom area.

As it can be seen in FIG. 2, “BreakControl” plug-in 23 is a configurable plug-in enabled to support additional plug-ins on its inside, since it contains another configurable control with a custom area thus enabling in another level of configuration. When the “BreakControl” plug-in 23 is plugged in the page, the configuration system recognizes it and through the configuration tool it is possible to configure its properties and behaviors.

As it is seen in FIG. 2, the “PersonOnBreakControl” plug-in 22 is inside the “Break Control plug-in 23. Advantageously, it is possible to configure also the behavior and the properties of the “PersonOnBreakControl” plug-in 22.

In addition to the embodiments of the present invention described above, skilled persons in the art will be able to arrive at a variety of other arrangements and steps which, if not explicitly described in this document, nevertheless fall within the scope of the appended claims. For example, with embodiments of the present invention, it is possible to modify the master view in the master-detail view.

### REFERENCES

[Ref.1] European Patent Application number 11195274.3

### Applicant: Siemens

Inventors: Belotti Simone, Noferi Stefano

1. A method for customizing a user-interface of a screen of a general purpose MES software application taking into account a set of customer requirements, the screen being a web-page, hereinafter called a page-screen, which method comprises the steps of:
a) providing within the general purpose MES software application at least one page-screen containing at least one configurable graphic control having at least one area that can be customized via at least one plug-in, the one area being a custom area;
b) providing a graphic configuration tool for enabling a configuration of the configurable graphic control of a page-screen user-interface in the at least one custom area;
c) enabling the at least one plug-in to be configured, the plug-in being a configurable plug-in;
d) enabling the graphic configuration tool to configure the configurable plug-in;
e) at engineering time, through the graphic configuration tool, exploring the page-screen so that, a tree is presented in which there is at least one node representing the configurable graphic control;
f) at engineering time, selecting a given node representing a given configurable graphic control and at least one associated custom area to be customized according to a given customer requirement thorough the configurable plug-in;
g) at engineering time, providing the configurable plug-in, wherein the configurable plug-in having software code with at least one additional configurable graphic control containing a custom area customizable via a nested plug-in;
h) at engineering time, specifying, through the graphic configuration tool, information of the configurable plug-in for linking the configurable plug-in to the custom area of the configurable graphic control;
i) at engineering time, through the graphic configuration tool, exploring the page-screen so that, under the node representing the configurable graphic control, a tree is presented in which there is at least one node representing the configurable plug-in having, underneath, at least one node representing the at least one additional configurable graphic control;
j) at engineering time, selecting a specific node representing a specific additional configurable graphic control containing at least one associated custom area to be customized according to an additional given customer requirement;
k) at engineering time, providing the nested plug-in which meets the additional given customer requirement; and
l) at engineering time, specifying, through the graphic configuration tool, information of the nested plug-in for linking it to the custom area of the additional configurable graphic control.

2. The method according to claim 1, wherein the nested plug-in is enabled to be configurable as well in order to meet a further customer requirement by including in the software code at least one further configurable graphic control containing at least one associated custom area customizable via a sub-nested plug-in; and by performing steps i) to l) accordingly, where the terms “configurable graphic control” are substituted with the terms “further configurable control”, the terms “additional given customer requirement” with the terms “further customer requirement”, the terms “configurable plug-in” with the terms “configurable nested plug-in”, the terms “nested plug-in” with the terms “sub-nested plug-in”.

3. The method according to claim 1, which further comprises storing, at engineering time, the information of steps h) and l) on a web server or on a database.

4. A method for displaying, at run time, a user-interface of a screen of a general purpose MES software application for performing the customization according to claim 1.

5. A software computer program having computer executable instructions for performing a method for customizing a user-interface of a screen of a general purpose MES software application taking into account a set of customer requirements, the screen being a web-page, hereinafter called a page-screen, which method comprises the steps of:
a) providing within the MES software application at least one page-screen containing at least one configurable graphic control having at least one area that can be customized via at least one plug-in, the one area being a custom area;
b) providing a graphic configuration tool for enabling a configuration of the configurable graphic control of a page-screen user-interface in the at least one custom area;
c) enabling the at least one plug-in to be configured, the plug-in being a configurable plug-in;
d) enabling the graphic configuration tool to configure the configurable plug-in;
e) at engineering time, through the graphic configuration tool, exploring the page-screen so that, a tree is presented in which there is at least one node representing the configurable graphic control;
f) at engineering time, selecting a given node representing a given configurable graphic control and at least one associated custom area to be customized according to a given customer requirement thorough the configurable plug-in;
g) at engineering time, providing the configurable plug-in, wherein the configurable plug-in having software code with at least one additional configurable graphic control containing the custom area customizable via a nested plug-in;
h) at engineering time, specifying, through the graphic configuration tool, information of the configurable plug-in for linking the configurable plug-in to the custom area of the configurable graphic control;
i) at engineering time, through the graphic configuration tool, exploring the page-screen so that, under the node representing the configurable graphic control, a tree is presented in which there is at least one node representing the configurable plug-in having, underneath, at least one node representing the at least one additional configurable graphic control;
j) at engineering time, selecting a specific node representing a specific additional configurable graphic control containing at least one associated custom area to be customized according to an additional given customer requirement;
k) at engineering time, providing the nested plug-in which meets the additional given customer requirement; and
l) at engineering time, specifying, through the graphic configuration tool, information of the nested plug-in for linking it to the custom area of the additional configurable graphic control.

6. A system, comprising:
a processor; and
a non-transitory memory storing software computer program having computer executable instructions to be execute by said processor, said computer executable instructions performing a method for customizing a user-interface of a screen of a general purpose MES software application taking into account a set of customer requirements, the screen being a web-page, hereinafter called a page-screen, which method comprises the steps of:
a) providing within the MES software application at least one page-screen containing at least one configurable graphic control having at least one area that can be customized via at least one plug-in, the one area being a custom area;
b) providing a graphic configuration tool for enabling a configuration of the configurable graphic control of a page-screen user-interface in the at least one custom area;
c) enabling the at least one plug-in to be configured, the plug-in being a configurable plug-in;
d) enabling the graphic configuration tool to configure the configurable plug-in;
e) at engineering time, through the graphic configuration tool, exploring the page-screen so that, a tree is presented in which there is at least one node representing the configurable graphic control;
f) at engineering time, selecting a given node representing a given configurable graphic control and at least one associated custom area to be customized according to a given customer requirement thorough the configurable plug-in;
g) at engineering time, providing the configurable plug-in, wherein the configurable plug-in having software code with at least one additional configurable graphic control containing the custom area customizable via a nested plug-in;
h) at engineering time, specifying, through the graphic configuration tool, information of the configurable plug-in for linking the configurable plug-in to the custom area of the configurable graphic control;
i) at engineering time, through the graphic configuration tool, exploring the page-screen so that, under the node representing the configurable graphic control, a tree is presented in which there is at least one node representing the configurable plug-in having, underneath, at least one node representing the at least one additional configurable graphic control;
j) at engineering time, selecting a specific node representing a specific additional configurable graphic control containing at least one associated custom area to be customized according to an additional given customer requirement;
k) at engineering time, providing the nested plug-in which meets the additional given customer requirement; and
l) at engineering time, specifying, through the graphic configuration tool, information of the nested plug-in for linking it to the custom area of the additional configurable graphic control.

7. A system for customizing a user-interface of a screen of a general purpose MES software application taking into account a set of customer requirements, the screen being a web-page, hereinafter called a page-screen, the system comprising:
a) means for providing within the general purpose MES software application at least one page-screen containing at least one configurable graphic control containing at least one area that can be customized via at least one plug-in, said one area being called a custom area;
b) means for providing a graphic configuration tool for enabling a configuration of the configurable graphic control of a page-screen user-interface in the at least one custom area;
c) means for enabling the at least one plug-in to be configured, said plug-in being a configurable plug-in;
d) means for enabling the graphic configuration tool to configure the configurable plug-in;
e) means for exploring, at engineering time, through the graphic configuration tool, the page-screen so that, a tree is presented in which there is at least one node representing the configurable graphic control;
f) means for selecting, at engineering time, a given node representing a given configurable graphic control and at least one associated custom area to be customized according to a given customer requirement thorough the configurable plug-in;
g) means for providing, at engineering time, said configurable plug-in, wherein software code of said configurable plug-in containing at least one additional configurable graphic control having a custom area customizable via a nested plug-in;
h) means for specifying, at engineering time, through the graphic configuration tool, information of the configurable plug-in for linking the configurable plug-in to the custom area of the configurable graphic control;
i) means for exploring, at engineering time, through the graphic configuration tool, the page-screen so that, under a node representing the configurable graphic control, a tree is presented in which there is at least one node representing the configurable plug-in having, underneath, at least one node representing the at least one additional configurable graphic control;
j) means for selecting, at engineering time, a specific node representing a specific additional configurable graphic control containing at least one associated custom area to be customized according to an additional given customer requirement;
k) means for providing, at engineering time, the nested plug-in which meets the additional given customer requirement; and
l) means for specifying, at engineering time, through the graphic configuration tool, information of the nested plug-in for linking the nested plug-in to the custom area of the additional configurable graphic control.
